(19) United States
(12) Patent Application Publication
(10) Pub. No.: US 2012/0005434 A1
(43) Pub. Date: Jan. 5, 2012

(54) SEMICONDUCTOR MEMORY APPARATUS

(75) Inventor: Sung Ho KIM, Ichon-si (KR)

(73) Assignee: Hynix Semiconductor Inc., Ichon-si (KR)

(21) Appl. No.: 12/962,501

(22) Filed: Dec. 7, 2010

(30) Foreign Application Priority Data
Jul. 2, 2010 (KR) 10-2010-0064008

(51) Int. Cl. G06F 12/00

(52) U.S. Cl. 711/147; 711/E12.001

(57) ABSTRACT

A semiconductor memory apparatus includes a data selection unit, a first data processing unit, and a second data processing unit. The data selection unit is configured to select one of the first and second transfer lines to be coupled to a data pad in response to address signals. The first data processing unit is connected to the first transfer line and a first memory bank of a plurality of memory banks, and performs a data input/output (I/O) operation between the first transfer line and the first memory bank. The second data processing unit is connected to the second transfer line and a second memory bank of the plurality of memory banks, which is different from the first memory bank, and performs a data input/output (I/O) operation between the second transfer line and the second memory bank.

### CROSS-REFERENCES TO RELATED APPLICATION

The present application claims priority under 35 U.S.C. §119(a) to Korean Application No. 10-2010-0064008, filed on Jul. 2, 2010, which is incorporated by reference in its entirety as if set forth in full.

### BACKGROUND OF THE INVENTION

1. Technical Field

Various embodiments relate to a semiconductor memory apparatus, and more particularly, to an efficient location and configuration of data input/output lines in the semiconductor memory apparatus.

2. Related Art

A semiconductor memory apparatus typically includes a plurality of memory cells to store data and a plurality of data input/output (I/O) lines and data pads to communicate with an external controller. The plurality of data I/O lines couple the data pads to a memory bank region to transfer data to and from the memory bank region in which the plurality of memory cells are located.

FIG. 1 is a block diagram showing a configuration of a conventional semiconductor memory apparatus. As shown in FIG. 1, the semiconductor memory apparatus includes eight memory banks BK0 to BK7, and also includes sixteen data pads DQ<0:15>. Therefore, the semiconductor memory apparatus may input or output sixteen serial data sets. Although the semiconductor memory apparatus in FIG. 1 needs sixteen data I/O lines in order to input or output data sets at a time, a semiconductor memory apparatus which converts the serial data to parallel data to perform a continuous read or write operation needs data I/O lines. For example, if a semiconductor memory apparatus has eight memory pads, then 128 data I/O lines are required from multiplying the sixteen data banks by the eight memory pads.

The more data I/O lines, the more difficult it is to speed up the operation of the SMA. Current consumption inevitably increases because the data I/O lines GIO_1 to GIO_4 assigned to the corresponding memory banks BK0 to BK7 should be all coupled to a single data I/O line GIO. For example, when outputting data stored in the first memory bank BK0, one driver transfers the data from the first memory bank BK0 while the other drivers that transfer data from the rest of memory banks, i.e., the second to eighth memory bank BK1 to BK7, turn off. Since the driver transfers data from the first memory bank BK0 through only one I/O line, a large data processing unit and a large driver are required to drive all the data through one line, resulting in a reduced driving speed. As shown in FIG. 1, the distance between the second memory bank BK1 and the eighth memory bank BK7 is about 1,000 micrometers. Therefore, the driver should face a load of the data I/O line GIO, which is located over a long length, at a time.

In addition, since the data I/O line GIO extends over all the memory banks, it is difficult to secure a chip area of the conventional semiconductor memory apparatus.

### SUMMARY OF THE INVENTION

The embodiments of the present invention include a semiconductor memory apparatus capable of substantially reducing a length of a data input/output (I/O) line.

In one embodiment of the present invention, a semiconductor memory apparatus includes: a data selection unit configured to select one of the first and second transfer lines to be coupled to a data pad in response to address signals; a first data processing unit which is connected to the first transfer line and a first memory bank of a plurality of memory banks and performs a data input/output (I/O) operation between the first transfer line and the first memory bank; and a second data processing unit which is connected to the second transfer line and a second memory bank of the plurality of memory banks, which is different from the first memory bank, and performs a data input/output (I/O) operation between the second transfer line and the second memory bank.

In another embodiment of the present invention, a semiconductor memory apparatus is provided that includes first to fourth memory banks of which the first and second memory banks are located on one side of the semiconductor memory apparatus and the third and fourth memory banks are located on an opposite side. The semiconductor memory apparatus also includes a data selection unit which is located among the first to fourth memory banks and communicates with first and second transfer lines and a data pad; a first data processing unit which is connected to the first transfer line and communicates with one of the first and second memory banks, the first data processing unit being located between the first and second memory banks; and a second data processing unit which is connected to the second transfer line and communicates with one of the third and fourth memory banks, the second data processing unit being located between the third and fourth memory banks.

In still another embodiment of the present invention, a semiconductor memory apparatus is provided that includes first to eighth memory banks of which the first to fourth memory banks are located on one side of the semiconductor memory apparatus and the fifth to eighth memory banks are located on an opposite side, and the first and second adjacent memory banks and the fifth and sixth adjacent memory banks are all located above and the third and fourth adjacent memory banks and the seventh and eighth adjacent memory banks are all located below. The semiconductor memory apparatus also includes a data selection unit which is located in a central area among the first to eighth memory banks and communicates with first and second transfer lines and a data pad; a first data processing unit which is located in the central area among the first to fourth memory banks and communicates with the first transfer line and the first to fourth memory banks; and a second data processing unit which is located in the central area among the fifth to eighth memory banks and communicates with the second transfer line and the fifth to eighth memory banks.

### BRIEF DESCRIPTION OF THE DRAWINGS

Features, aspects, and embodiments are described in conjunction with the attached drawings, in which;

FIG. 1 is a block diagram showing a configuration of a conventional semiconductor memory apparatus;

FIG. 2 is a block diagram showing a configuration of a semiconductor memory apparatus according to an embodiment of the present invention;

FIG. 3 is a diagram showing a configuration of a first memory bank and a first data processing unit of FIG. 2; and

FIG. 4 is a diagram showing a configuration of a data selection unit of FIG. 2.

### DETAILED DESCRIPTION OF THE PREFERRED EMBODIMENTS

Hereinafter, a semiconductor memory apparatus, according to the present invention, will be described below with reference to the accompanying drawings through preferred embodiments.

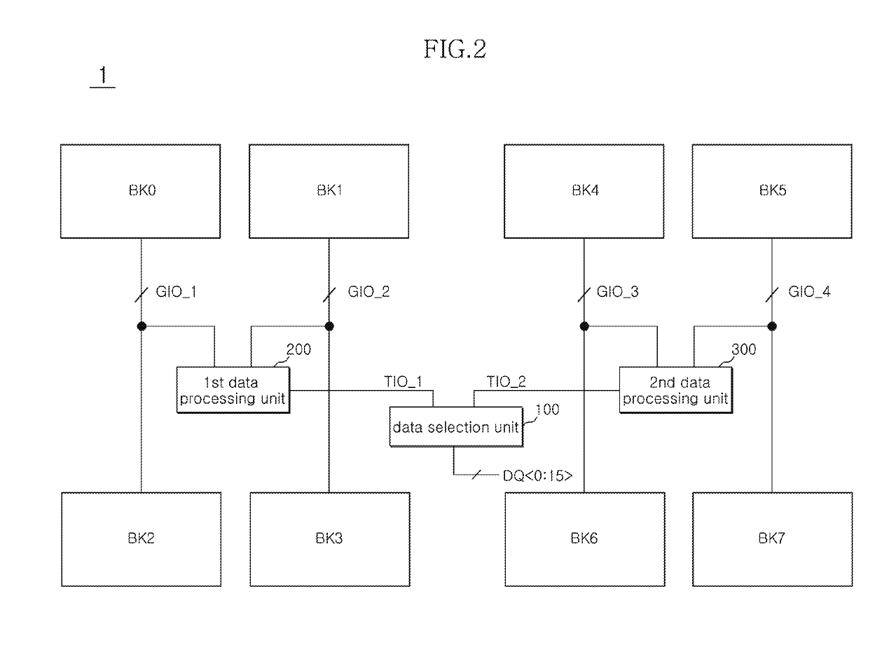

FIG. 2 is a block diagram showing a configuration of a semiconductor memory apparatus 1 according to an embodiment of the present invention. In FIG. 2, the semiconductor memory apparatus 1 includes first to eighth memory banks BK0 to BK7, but it should be understood that the number of memory banks is merely exemplary and that there is no intention to limit example embodiments thereto. As shown in FIG. 2, the first to fourth memory banks BK0 to BK3 are located on the left, whereas the fifth to eighth memory banks BK4 to BK7 are located on the right. The first and second memory banks BK0 and BK1 are adjacently located above, whereas the third and fourth memory banks BK2 and BK3 are adjacently located below. Likewise, the fifth and sixth memory banks BK4 and BK5 are adjacently located above, whereas the seventh and eighth memory banks BK6 and BK7 are adjacently located below.

The semiconductor memory apparatus 1 includes a data selection unit 100, a first data processing unit 200, and a second data processing unit 300. The data selection unit 100 is coupled to data pads DQ<0:15>, a first transfer line TIO_1, and a second transfer line TIO 2. These transfer lines TIO_1 and TIO_2 allow the data selection unit to communicate with the data pads DQ<0:15>, the first data processing unit 200, and the second data processing unit 300, respectively. The data selection unit 100 outputs data inputted through the data pads DQ<0:15> to either the first or second transfer line TIO_1 and TIO_2. Conversely, the data selection unit 100 outputs data inputted through the first and second transfer lines TIO_1 and TIO_2 to the data pads DQ<0:15>.

The data selection unit 100 may selectively communicate with the first and second transfer lines TIO_1 and TIO_2 in response to address signals ‘ADD’. The address signals ‘ADD’ may be signals which are inputted from outside of the semiconductor memory apparatus 1 so as to select the first to eighth memory banks BK0 to BK7. Since the semiconductor memory apparatus 1 includes 8 number of memory banks, the first to eighth memory banks BK0 to BK7 may be individually selected by using, for example, three address signals. Therefore, the data selection unit 100 may use any one of the address signals.

The first data processing unit 200 is coupled to the first to fourth memory banks BK0 to BK3, and is also coupled to the first transfer line TIO_1 in order to communicate with the data selection unit 100. The first data processing unit 200 is coupled to the first and third memory banks BK0 and BK2 through a first data input/output (I/O) line GIO_1, and is coupled to the second and fourth memory banks BK1 and BK3 through a second data I/O line GIO_2.

The first data processing unit 200 receives parallel data outputted from the first to fourth memory banks BK0 to BK3, and converts the parallel data to serial data to output the serial data to the first transfer line TIO_1. In addition, the first data processing unit 200 receives serial data from the first transfer line TIO_1, and converts the serial data to parallel data to output the parallel data to the first to fourth memory banks BK0 to BK3. The first data processing unit 200 selectively communicates with either of the first and second data I/O lines GIO_1 and GIO_2 in response to the address signals ‘ADD’. Therefore, in response to the address signals ‘ADD’, the first data processing unit 200 may communicate with the first and third memory banks BK0 and BK2 or with the second and fourth memory banks BK1 and BK3.

Like the first data processing unit 200, the second data processing unit 300 is coupled to the fifth to eighth memory banks BK4 to BK7, and is also coupled to the second transfer line TIO_2 to communicate with the data selection unit 100. The second data processing unit 300 is coupled to the fifth and seventh memory banks BK4 and BK6 through a third data I/O line GIO_3, and is coupled to the sixth and eighth memory banks BK5 and BK7 through a fourth data I/O line GIO_4.

Like the first data processing unit 200, the second data processing unit 300 receives parallel data outputted from the fifth to eighth memory banks BK4 to BK7, and converts the parallel data to serial data, which is output to the second transfer line TIO_2. In addition, the second data processing unit 300 receives serial data from the second transfer line TIO_2, and converts the serial data to parallel data, which is output to the fifth to eighth memory banks BK4 to BK7. The second data processing unit 300 selectively communicates with either the third and fourth data I/O lines GIO_3 and GIO_4 in response to the address signals ‘ADD’. Therefore, the second data processing unit 300 may communicate with the fifth and seventh memory banks BK4 and BK6 or with the sixth and eighth memory banks BK5 and BK7 in response to the address signals ‘ADD’.

FIG. 2 also shows a location of elements of the semiconductor memory apparatus 1. The data selection unit 100 is located in the central area among the first to eighth memory banks BK0 to BK7. The first data processing unit 200 is located in the central area among the first to fourth memory banks BK0 to BK3, whereas the second data processing unit 300 is located in the central area among the fifth to eighth memory banks BK4 to BK7. To describe this location numerically, the data selection unit 100 is located at about a half (½) the horizontal length along which the first to eighth memory banks BK0 to BK7 are located, from the leftmost, and the first data processing unit 200 is located at about a quarter (¼) the horizontal length from the leftmost, and the second data processing unit 300 is located at about three quarters (¾) the horizontal length from the leftmost. Therefore, a length between the data selection unit 100 and the first data processing unit 200 and a length between the data selection unit 100 and the second data processing unit 300 are substantially the same. In addition, a horizontal length of the first transfer line TIO_1 coupling the data selection unit 100 to the first data processing unit 200 and horizontal lengths of the first and second data I/O lines GIO_1 and GIO_2 respectively coupling the first data processing unit 200 to the first to fourth memory banks BK0 to BK3 are all substantially the same. Likewise, a horizontal length of the second transfer line TIO_2 coupling the data selection unit 100 to the second data processing unit 300 and horizontal lengths of the third and fourth data I/O lines GIO_3 and GIO_4 respectively coupling the second data processing unit 300 to the fifth to eighth memory banks BK4 to BK7 are all substantially the same.

In this location and configuration, the semiconductor memory apparatus 1 includes the data selection unit 100 so that a length and a load of the data I/O line in the case where data is inputted or outputted to or from the first to fourth memory banks BK0 to BK3 and a length and a load of the data I/O line in the case where data is inputted or outputted to or from the fifth to eighth memory banks BK4 to BK7, respectively, may be about a half (½) the length and the load of the data I/O line in the prior art. Moreover, since the first data processing unit 200 is selectively coupled to two memory banks of the first to fourth memory banks BK0 to BK3 and the second data processing unit 300 is selectively coupled to two memory banks of the fifth to eighth memory banks BK4 to BK7, the length and the load of the data I/O line in the embodiment may be about a quarter (¼) the length and the load of the data I/O line in the prior art, respectively. Therefore, since the load of the data I/O line which is driven based on data when the data is transferred through the data I/O line is substantially reduced, it is possible to substantially reduce a size of a driver which drives the data I/O line and a current which is consumed in the driver.

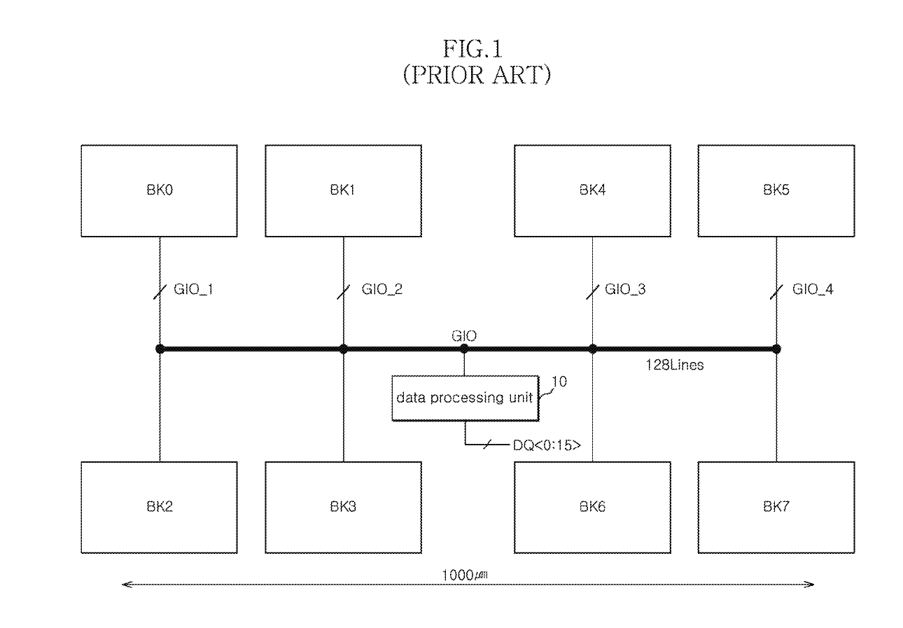

For example, in case of a semiconductor memory apparatus which 16 number of data may be inputted or outputted to or from at a time and performs a continuous read or write operation to have a burst length of 8, the number of the first to fourth data I/O lines GIO_1 to GIO_4 is 128 like in the prior art. Herein, in the prior art, it was difficult to secure a chip area, because the 128 number of data I/O lines are located over the entire region among the first to eighth memory banks BK0 to BK7 (refer to FIG. 1). In the semiconductor memory apparatus 1 according to the embodiment, however, it is easier to secure the chip area than in the prior art, because it is sufficient that the first and second data I/O lines GIO_1 and GIO_2 are located between the first data processing unit 200 and the first to fourth memory banks BK0 to BK3 and the third and fourth data I/O lines GIO_3 and GIO_4 are located between the second data processing unit 300 and the fifth to eighth memory banks BK4 to BK7.

Since each of the first and second transfer lines TIO_1 and TIO_2 is a path through which serial data is transferred, the number of the first and second transfer lines TIO_1 and TIO_2 is substantially the same as the number of data pads DQ<0:15>. Therefore, the number of the first and second transfer lines TIO_1 and TIO_2 may be 16.

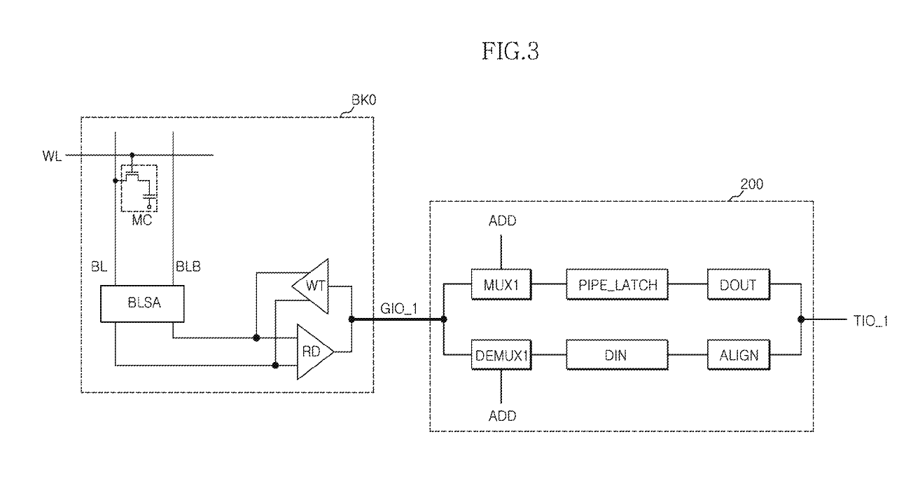

FIG. 3 is a diagram showing a configuration of the first memory bank BK0 and the first data processing unit 200 of FIG. 2. As shown in FIG. 3, the first memory bank BK0 includes a word line WL, a bit line pair BL and BLB, a memory cell MC, a bit line sense amplifier BLSA, a read driver RD, and a write driver WT. The first data processing unit 200 includes a data alignment unit ALIGN, an input buffer DIN, a first demultiplexer DEMUX1, a first multiplexer MUX1, a pipe latch PIPE_LATCH, and an output buffer DOUT.

In this configuration, a data input/output operation will now be described with reference to FIGS. 2 and 3. Herein, it is exemplified that data is inputted or outputted to or from the first memory bank BK0.

Firstly, to describe a data input operation, serial data inputted through the data pads DQ<0:15> is inputted to the data selection unit 100, and then the data selection unit 100 outputs the data to the first transfer line TIO_1 in response to the address signals ‘ADD’. The serial data transferred through the first transfer line TIO_1 is inputted to the first data processing unit 200. The serial data is converted to parallel data by the data alignment unit ALIGN. The parallel data is amplified by the input buffer DIN and is outputted to the first data I/O line GIO_1 through the first demultiplexer DEMUX1. Although not shown in FIG. 3, the first demultiplexer DEMUX1 is coupled to the second data I/O line GIO_2 as well as the first data I/O line GIO_1, thereby may output the data to the second data I/O line GIO_2 in response to the address signals ‘ADD’.

The data outputted from the first demultiplexer DEMUX1 is inputted to the write driver WT through the first data I/O line GIO_1, and the write driver WT amplifies the data transferred through the first data I/O line GIO_1, and the amplified data is loaded on the bit line pair BL and BLB through the bit line sense amplifier BLSA and thereby may be stored in the memory cell MC.

Reversely, to describe a data output operation, data stored in the memory cell MC is loaded on the bit line pair BL and BLB as the word line WL is enabled, and is amplified through use of the bit line sense amplifier BLSA, and then is inputted to the read driver RD. The read driver RD amplifies the inputted data to output the amplified data to the first data I/O line GIO_1. The first multiplexer MUX1 receives the parallel data transferred from the first data I/O line GIO_1 in response to the address signals ‘ADD’. The pipe latch PIPE_LATCH converts parallel data outputted from the second multiplexer MUX2 to serial data, and the output buffer DOUT amplifies and outputs the serial data outputted from the pipe latch PIPE_LATCH. The serial data is inputted to the data selection unit 100 through the first transfer line TIO_1, and then the data selection unit 100 outputs the data to the data pads DQ<0:15>. Therefore, the data stored in the first memory bank BK0 may be outputted through the data pads DQ<0:15>.

The second data processing unit 300 has substantially the same configuration as the first data processing unit 200, and may input/output to or from the fifth to eighth memory banks BK4 to BK7 like the first data processing unit 200, thus a repeated description will be omitted thereon.

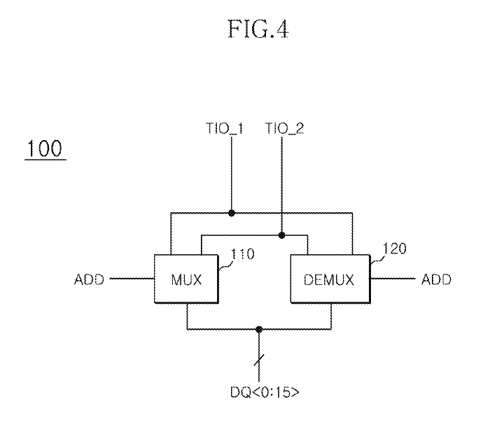

FIG. 4 is a diagram showing a configuration of the data selection unit 100 of FIG. 2. As shown in FIG. 4, the data selection unit 100 includes a multiplexer unit (MUX) 110 and a demultiplexer unit (DEMUX) 120. In response to the address signals ‘ADD’, the multiplexer unit 110 receives data from the data pads DQ<0:15>, and selectively outputs the data to either the first or second transfer lines TIO_1 and TIO_2. On the other hand, the same address signals ‘ADD’ cause the demultiplexer unit 120 to receive data from either the first or second transfer lines TIO_1 and TIO_2 and output the data to the data pads DQ<0:15>.

Therefore, since the address signals ‘ADD’ cause the data selection unit 100 to communicate with either the first or second transfer lines TIO_1 and TIO_2, the data selection unit 100 may selectively communicate with the first and second data processing units 200 and 300.

When the data is inputted or outputted to or from the first memory bank BK0, the data selection unit 100 is coupled to the first transfer line TIO_1. This configuration substantially reduces the length and the data load I/O line to about one-half of the length and data load depicted in the prior art. Since the first data processing unit 200 is coupled to the first data I/O line GIO_1 out of the first and second data I/O lines GIO_1 and GIO_2 and a horizontal length of the first data I/O line GIO_1 is a one-quarter of the distance between first and eighth memory banks BK0 to BK7 depicted in the prior art. Accordingly, the length and the data load I/O line through which the data is transferred to or from the first memory bank BK0 may be reduced to about one-quarter of the length and data load depicted in the prior art. Moreover, the same data load reduction occurs when data is inputted or outputted to or from any of the second to eighth memory banks BK1 to BK7.

Therefore, it is possible to substantially reduce a size of a driver which drives the data I/O line, such as the write driver WT, the read driver RD, the input buffer DIN, and the output buffer DOUT, and a current consumed in the driver. In addition, it is easier to secure the chip area of the semiconductor memory apparatus in this exemplary embodiment compared to the prior art, because the data I/O line is not located over the entire region among the memory banks.

While certain embodiments have been described above, it will be understood to those skilled in the art that the embodiments described are by way of example only. Accordingly, the device and method described herein should not be limited based on the described embodiments. Rather, the apparatus described herein should only be limited in light of the claims that follow when taken in conjunction with the above description and accompanying drawings.

What is claimed is:

1. A semiconductor memory apparatus comprising:
a data selection unit configured to select one of the first and second transfer lines to be coupled to a data pad in response to address signals;
a first data processing unit which is coupled to the first transfer line and a first memory bank of a plurality of memory banks and performs a data input/output (I/O) operation between the first transfer line and the first memory bank; and
a second data processing unit which is coupled to the second transfer line and a second memory bank of the plurality of memory banks and performs a data input/output (I/O) operation between the second transfer line and the second memory bank.

2. The semiconductor memory apparatus according to claim 1, wherein the data selection unit includes:
a multiplexer unit configured to output data inputted through the data pad to one of the first and second transfer lines in response to the address signals; and
a demultiplexer unit configured to output data inputted through one of the first and second transfer lines in response to the address signals to the data pad.

3. The semiconductor memory apparatus according to claim 1, wherein the first data processing unit is configured to receive parallel data from the first memory bank and convert the parallel data to serial data to output the serial data to the first transfer line, and to receive serial data from the first transfer line and convert the serial data to parallel data to output the parallel data to the memory bank.

4. The semiconductor memory apparatus according to claim 1, wherein the second data processing unit is configured to receive parallel data from the memory bank and convert the parallel data to serial data to output the serial data to the second transfer line, and to receive serial data from the second transfer line and convert the serial data to parallel data to output the parallel data to the memory bank.

5. A semiconductor memory apparatus including first to fourth memory banks of which the first and second memory banks are located on one side of the semiconductor memory apparatus and the third and fourth memory banks are located on an opposite side, comprising:
a data selection unit which is located among the first to fourth memory banks and communicates with first and second transfer lines and a data pad;
a first data processing unit which is coupled to the first transfer line and communicates with one of the first and second memory banks; and
a second data processing unit which is coupled to the second transfer line and communicates with one of the third and fourth memory banks.

6. The semiconductor memory apparatus according to claim 5, wherein the data selection unit includes:
a multiplexer unit configured to output data inputted through the data pad to one of the first and second transfer lines in response to the address signals; and
a demultiplexer unit configured to output data inputted through one of the first and second transfer lines in response to the address signals to the data pad.

7. The semiconductor memory apparatus according to claim 5, wherein the first data processing unit is configured to receive parallel data from one of the first and second memory banks and convert the parallel data to serial data to output the serial data to the first transfer line, and to receive serial data from the first transfer line and convert the serial data to parallel data to output the parallel data to one of the first and second memory banks.

8. The semiconductor memory apparatus according to claim 5, wherein the second data processing unit is configured to receive parallel data from one of the third and fourth memory banks and convert the parallel data to serial data to output the serial data to the second transfer line, and to receive serial data from the second transfer line and convert the serial data to parallel data to output the parallel data to one of the third and fourth memory banks.

9. A semiconductor memory apparatus including first to eighth memory banks of which the first to fourth memory banks are located on one side of the semiconductor memory apparatus and the fifth to eighth memory banks are located on an opposite side, and the first and second adjacent memory banks and the fifth and sixth adjacent memory banks are all located above and the third and fourth adjacent memory banks and the seventh and eighth adjacent memory banks are all located below, comprising:
a data selection unit which is located in a central area among the first to eighth memory banks and communicates with first and second transfer lines and a data pad;
a first data processing unit which is located in the central area among the first to fourth memory banks and communicates with the first transfer line and the first to fourth memory banks; and
a second data processing unit which is located in the central area among the fifth to eighth memory banks and communicates with the second transfer line and the fifth to eighth memory banks.

10. The semiconductor memory apparatus according to claim 9, wherein the data selection unit includes:
a multiplexer unit configured to output data inputted through the data pad to one of the first and second transfer lines in response to an address signal; and
a demultiplexer unit configured to output data inputted through one of the first and second transfer lines in response to the address signals to the data pad.

11. The semiconductor memory apparatus according to claim 9, wherein the first data processing unit is configured to receive parallel data from the first to fourth memory banks and convert the parallel data to serial data to output the serial data to the first transfer line, and to receive serial data from the first transfer line and convert the serial data to parallel data to output the parallel data to the first to fourth memory banks.

12. The semiconductor memory apparatus according to claim 9, wherein the first data processing unit is configured to selectively communicate with the first and third memory banks or the second and fourth memory banks in response to an address signal.

13. The semiconductor memory apparatus according to claim 9, wherein the second data processing unit is configured to receive parallel data from the fifth to eighth memory banks and convert the parallel data to serial data to output the serial data to the second transfer line, and to receive serial data from the second transfer line and convert the serial data to parallel data to output the parallel data to the fifth to eighth memory banks.

14. The semiconductor memory apparatus according to claim 9, wherein the second data processing unit is configured to selectively communicate with the fifth and seventh memory banks or the sixth and eighth memory banks in response to an address signal.

15. The semiconductor memory apparatus according to claim 9, wherein the semiconductor memory apparatus further includes a first data I/O line configured to couple the first data processing unit to the first and third memory banks.

16. The semiconductor memory apparatus according to claim 15, wherein the semiconductor memory apparatus further includes a second data I/O line configured to couple the first data processing unit to the second and fourth memory banks.

17. The semiconductor memory apparatus according to claim 16, wherein a horizontal length of the first data I/O line, a horizontal length of the second data I/O line, and a horizontal length of the first transfer line are all substantially the same.

18. The semiconductor memory apparatus according to claim 9, wherein the semiconductor memory apparatus further includes a third data I/O line configured to couple the second data processing unit to the fifth and seventh memory banks.

19. The semiconductor memory apparatus according to claim 18, wherein the semiconductor memory apparatus further includes a fourth data I/O line configured to couple the second data processing unit to the sixth and eighth memory banks.

20. The semiconductor memory apparatus according to claim 19, wherein a horizontal length of the third data I/O line, a horizontal length of the fourth data I/O line, and a horizontal length of the second transfer line are all substantially the same.
